(19) United States
(12) Patent Application Publication
(10) Pub. No.: US 2025/0389606 A1
(43) Pub. Date: Dec. 25, 2025

(54) A Torque Tester for Verifying Multiple Electronic Torque Wrenches

(71) Applicant: Apex Brands, Inc., Apex, NC (US)

(72) Inventors: Bin Sun, Shanghai (CN); Henglian Luo, Shanghai (CN); Tong Li, Shanghai (CN)

(21) Appl. No.: 19/107,942

(22) PCT Filed: Sep. 1, 2022
(86) PCT No.: PCT/CN2022/116471

§ 371 Date: Feb. 28, 2025

(51) Int. Cl. G01L 25/00; B25B 23/142

(52) U.S. Cl. CPC G01L 25/003; B25B 23/1425

(57) ABSTRACT

A method is provided for verifying an electronic torque wrench. The method includes determining a reference torque value at a torque tester, from a torque applied by an electronic torque wrench to the torque tester with which the electronic torque wrench is engaged. The method includes receiving multiple torque values at the torque tester contemporaneous with the reference torque value determined at the torque tester, the multiple torque values received from multiple electronic torque wrenches, including the electronic torque wrench engaged with the torque tester. The method includes identifying one of the multiple torque values as a torque value from the electronic torque wrench, based on the reference torque value and the multiple torque values. The method includes performing a verification of the electronic torque wrench based on the reference torque value and the torque value as identified; and outputting an indication of the verification of the electronic torque wrench.

### TECHNOLOGICAL FIELD

The present disclosure relates generally to torque application and measurement devices and, in particular, to an apparatus for torque measurement such as an electronic torque wrench.

### BACKGROUND

Fasteners are often used to assemble performance critical components are tightened to a specified torque level to introduce a “pretension” in the fastener. As torque is applied to the head of the fastener, the fastener may begin to stretch beyond a certain level of applied torque. This stretch results in the pretension in the fastener which then holds the components together. Additionally, it is often necessary to further rotate the fastener through a specified angle after the desired torque level has been applied. A popular method of tightening these fasteners is to use a torque wrench.

Torque wrenches may be of mechanical or electronic type. Mechanical torque wrenches are generally less expensive than electronic. There are two common types of mechanical torque wrenches, beam and clicker types. In a beam type torque wrench, a beam bends relative to a non-deflecting beam in response to applied torque. The amount of deflection of the bending beam relative to the non-deflecting beam indicates the amount of torque applied to the fastener. Clicker type torque wrenches have a selectable preloaded snap mechanism with a spring to release at a specified, target torque, thereby generating a click noise to alert the operator to release force on the wrench from which the applied torque is produced.

Electronic torque wrenches tend to be more expensive than mechanical torque wrenches. Many electronic torque wrenches include a user interface with a human input device and an electronic visual display. The electronic torque wrench may receive a target torque through its user interface; and when applying torque to a fastener with an electronic torque wrench, torque readings may be indicated on the electronic visual display that relate to the pretension in the fastener due to the applied torque. The electronic torque wrench may also alert the operator to release the force on the wrench when the applied torque reaches the target torque.

A number of programs in which torque wrenches are used include use of a torque tester to periodically test the torque wrenches to verify they are within specification. A work area in which a torque wrench is being verified may include multiple torque wrenches that are waiting for verification. In some cases, the torque wrench and torque tester may be connected by wire, which enables the torque tester to recognize the torque wrench being verified; but this requires extra work to connect the torque wrench and torque tester by wire. In other cases, the torque wrench and torque tester may be connected wirelessly; but in this case, an operator typically must still identify the torque wrench to the torque tester, as the torque tester may also be wirelessly connected to or otherwise in radio range of others of the torque wrenches in the work area.

It would therefore be desirable to have a system and method that addresses the above issue, as well as other possible issues.

### BRIEF SUMMARY

Example implementations of the present disclosure are directed to an apparatus such as a torque tester or computer for verifying multiple electronic torque wrenches or other torque measurement devices. The present disclosure includes, without limitation, the following example implementations.

Some example implementations provide a torque tester for verifying an electronic torque wrench, the torque tester comprising: a recess configured to engage a boss of an electronic torque wrench, and thereby engage the electronic torque wrench with the torque tester; and processing circuitry configured to cause the torque tester to at least: determine a reference torque value at a torque tester, from a torque applied by an electronic torque wrench to the torque tester with which the electronic torque wrench is engaged; receive multiple torque values at the torque tester contemporaneous with the reference torque value determined at the torque tester, the multiple torque values received from multiple electronic torque wrenches, including the electronic torque wrench engaged with the torque tester; identify one of the multiple torque values as a torque value from the electronic torque wrench, based on the reference torque value and the multiple torque values; perform a verification of the electronic torque wrench based on the reference torque value and the torque value as identified; and output an indication of the verification of the electronic torque wrench.

Some example implementations provide a torque tester for verifying multiple electronic torque wrenches, the torque tester comprising: a recess configured to engage a boss of an electronic torque wrench, and thereby engage the electronic torque wrench with the torque tester; and processing circuitry configured to cause the torque tester to at least: connect the torque tester to the multiple electronic torque wrenches that are in radio range of the torque tester, and thereby establish radio links between the torque tester and the multiple electronic torque wrenches; verify an electronic torque wrench of the multiple electronic torque wrenches, including the torque tester caused to: determine a reference torque value at a torque tester, from a torque applied by the electronic torque wrench to the torque tester with which the electronic torque wrench is engaged; receive multiple torque values at the torque tester contemporaneous with the reference torque value determined at the torque tester, the multiple torque values received from the multiple electronic torque wrenches, wirelessly by radio communication over the radio links; identify one of the multiple torque values as a torque value from the electronic torque wrench, based on the reference torque value and the multiple torque values; perform a verification of the electronic torque wrench based on the reference torque value and the torque value as identified; and output an indication of the verification of the electronic torque wrench; disconnect the electronic torque wrench from the torque tester after the verification of the electronic torque wrench is performed; and repeat the verifying and disconnecting for others of the multiple electronic torque wrenches that are connected to the torque tester after the electronic torque wrench is disconnected.

Some example implementations provide a method of verifying an electronic torque wrench, the method comprising: determining a reference torque value at a torque tester, from a torque applied by an electronic torque wrench to the torque tester with which the electronic torque wrench is engaged; receiving multiple torque values at the torque tester contemporaneous with the reference torque value determined at the torque tester, the multiple torque values received from multiple electronic torque wrenches, including the electronic torque wrench engaged with the torque tester; identifying one of the multiple torque values as a torque value from the electronic torque wrench, based on the reference torque value and the multiple torque values; performing a verification of the electronic torque wrench based on the reference torque value and the torque value as identified; and outputting an indication of the verification of the electronic torque wrench.

Some example implementations provide a method of verifying multiple electronic torque wrenches, the method comprising: connecting the torque tester to the multiple electronic torque wrenches that are in radio range of the torque tester, and thereby establish radio links between the torque tester and the multiple electronic torque wrenches; verifying an electronic torque wrench of the multiple electronic torque wrenches, including: determining a reference torque value at a torque tester, from a torque applied by the electronic torque wrench to the torque tester with which the electronic torque wrench is engaged; receiving multiple torque values at the torque tester contemporaneous with the reference torque value determined at the torque tester, the multiple torque values received from the multiple electronic torque wrenches, wirelessly by radio communication over the radio links; identifying one of the multiple torque values as a torque value from the electronic torque wrench, based on the reference torque value and the multiple torque values; performing a verification of the electronic torque wrench based on the reference torque value and the torque value as identified; and outputting an indication of the verification of the electronic torque wrench; disconnecting the electronic torque wrench from the torque tester after the verification of the electronic torque wrench is performed; and repeating the verifying and disconnecting for others of the multiple electronic torque wrenches that are connected to the torque tester after the electronic torque wrench is disconnected.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIGS. 1A and 1B illustrate an electronic torque wrench, according to some example implementations of the present disclosure;

FIG. 2 is a block diagram of an apparatus for determining an applied torque, and that may correspond to the electronic torque wrench of FIG. 1, according to some example implementations;

FIGS. 3 illustrates a system for verifying a torque measurement device such as an electronic torque wrench of multiple electronic torque wrenches, according to various example implementations;

FIGS. 4A, 4B and 4C are flowcharts illustrating various steps in a method of verifying an electronic torque wrench, according to various example implementations; and

FIG. 5 is a flowchart illustrating various steps in a method of verifying multiple electronic torque wrenches, according to various example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably.

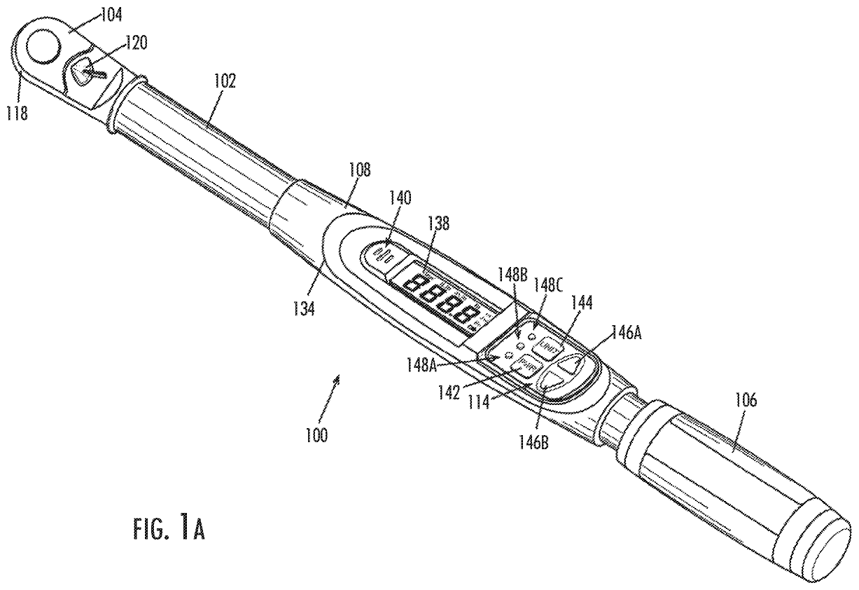

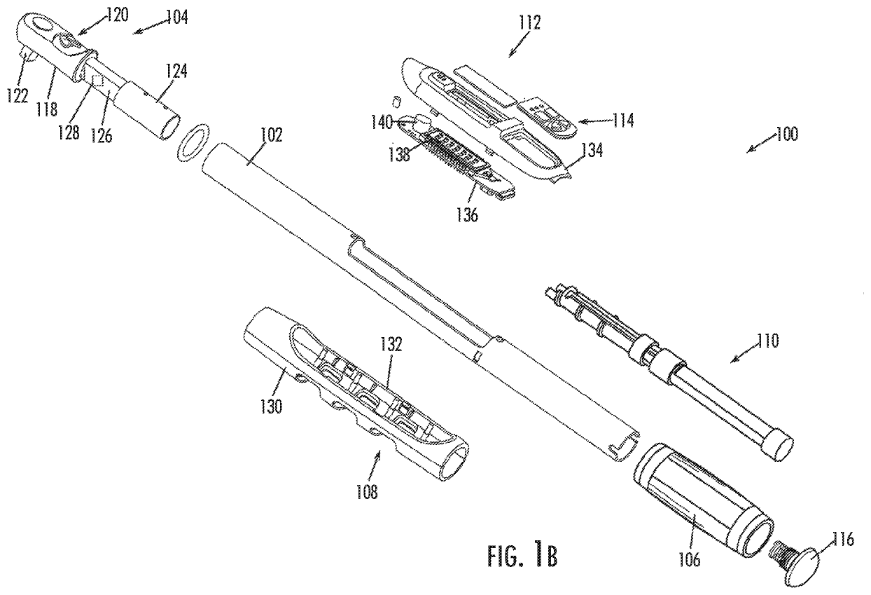

Example implementations of the present disclosure relate generally to torque application and measurement devices. Example implementations will primarily be described in the context of an electronic torque wrench. Other examples of suitable torque measurement devices include a torque tester, torque meter, torque transducer or the like. FIGS. 1A and 1B illustrate an electronic torque wrench 100 according to some example implementations of the present disclosure. As shown, the electronic torque wrench includes a wrench body 102, a wrench head 104 (e.g., a ratcheting wrench head), a grip handle 106, a housing 108, a battery assembly 110, and an electronics unit 112 with a user interface 114. In some examples, the wrench body is of tubular construction, made of steel or other rigid material, and receives the wrench head at a first end and the battery assembly at a second end, secured therein by an end cap 116. In some of these examples, the housing is mounted therebetween and carries the electronics unit.

As shown, a front end 118 of the wrench head 104 includes a coupler with a lever 120 that allows a user to select whether torque is applied to a fastener in either a clockwise (CW) or counter-clockwise (CCW) direction. The front end also includes a male square drive or boss 122 for receiving variously sized sockets, extensions, etc. A rear end 124 of the wrench head is slidably received in the wrench body 102 and rigidly secured therein. The wrench head includes at least one vertical flat portion 126 formed between the front end and the rear end for receiving a strain gauge assembly 128. The flat portion of the wrench head is both transverse to the plane of rotation of torque wrench 100 and parallel to the longitudinal center axis of the wrench head. The strain gauge assembly includes one or more strain gauges. In some examples, the strain gauge assembly is a full-bridge assembly including four separate strain gauges on a single film that is secured to the flat portion of the wrench head. Together, the full-bridge strain gauge assembly mounted on the flat portion of the wrench head is referred to as a strain tensor.

As also shown, the housing 108 includes a bottom portion 130 that is slidably received about the wrench body 104 and defines an aperture 132 for receiving a top portion 134 that carries the electronics unit 112. The electronics unit provides the user interface 114 for the operation of the electronic torque wrench 100. The electronics unit includes a circuit board 136 including a digital display 138 and an annunciator 140 mounted thereon. The portion of the housing defines an aperture that receives the user interface, which includes a power button 142, a unit selection button 144, increment/decrement buttons 146A and 146B, and three light emitting diodes (LEDs) 148A, 148B and 148C. And the LEDs may illuminate green, yellow and red, respectively, when activated.

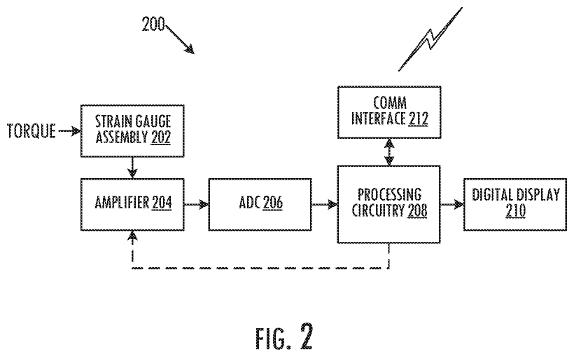

FIG. 2 illustrates a torque measurement device 200 for determining a torque value of an applied torque, according to some example implementations. The torque measurement device may be embodied in a number of different manners, and in some examples, the torque measurement device is an electronic torque wrench such as electronic torque wrench 100. In other examples, the torque measurement device is a torque tester, torque meter, torque transducer or the like. As shown, the torque measurement device includes a strain gauge assembly 202 (e.g., strain gauge assembly 128), an amplifier 204, an analog-to-digital converter (ADC) 206, and processing circuitry 208. In some examples in which the torque measurement device 200 corresponds to electronic torque wrench 100, the amplifier ADC and processing circuitry may be components of the electronics unit 112, carried by the circuit board 136.

The strain gauge assembly 202 is configured to measure an applied torque such as the torque applied to a fastener when the torque measurement device 200 is an electronic torque wrench, and produce an analog electrical signal that varies in voltage with the torque. The amplifier 204 is configured to receive the analog electrical signal, and increase an amplitude of the analog electrical signal to produce an amplified, analog electrical signal.

The ADC 206 is configured to convert the amplified, analog electrical signal to an equivalent digital electrical signal. The processing circuitry 208, then, is configured to determine the torque value of the torque applied to the fastener from the equivalent digital electrical signal, and output an indication of the torque value. In some examples, the equivalent digital electrical signal includes digital data points; and in some of these examples, the processing circuitry is configured to determine a subset of the digital data points in a moving sample window, and calculate the torque value from a rolling average of the subset of the digital data points in the moving sample window.

The processing circuitry 208 may output the indication of the torque value in a number of different manners. In some examples, the torque measurement device 200 further includes a digital display 210 (e.g., digital display 138), and the processing circuitry is configured to output the indication of the torque value to the digital display that is configured to display the torque value.

As also shown, the torque measurement device 200 may include a communication interface 212 is configured to enable the torque measurement device to telecommunicate with another apparatus by wire, or wirelessly by radio or optical communication. As described herein, the communication interface is an electronic circuit; and in various examples, the communication interface includes a cable connector, an antenna or optoelectronics for the electronic transmission of information over a data link between the apparatus and computer/computer hardware. Examples of suitable communication interfaces include a network interface controller (NIC), wireless NIC (WNIC) or the like.

To further illustrate calculation of the torque value according to various example implementations, consider an example in which the processing circuitry 208 samples one thousand digital data points per second and uses a moving sample window of ten milliseconds. As torque is applied, the processing circuitry may average the first ten digital data points, one taken each millisecond, thereby producing a first equivalent digital value at time t=0.01 seconds, wherein t=0.0 seconds marks initiation of the torquing operation. At time t=0.011 seconds, the processing circuitry may average the digital data points taken between times t=0.002 and t=0.011 seconds, thereby producing a second equivalent digital value. At time t=0.012 seconds, the processing circuitry may average the digital data points taken between times t=0.003 seconds and t=0.012 seconds, thereby producing a third equivalent digital value. And this may continue such that an equivalent digital value may be provided every millisecond until the torque is no longer applied. In short, the processing circuitry may utilize a digital filtering algorithm to provide a rolling average in which the oldest digital data point is dropped each time a new digital data point is received within the moving sample window.

As explained in the background section, a number of programs in which torque wrenches are used include use of a torque tester to periodically test the torque wrenches to verify they are within specification. A work area in which a torque wrench is being verified may include multiple torque wrenches that are waiting for verification, and a torque tester may be wirelessly connected to or otherwise in radio range of the multiple torque wrenches including a torque wrench being verified. Example implementations of the present disclosure provide a torque tester configured to identify one of multiple electronic torque wrenches that is being verified, without a wired connection or an operator identifying the electronic torque wrench to the torque tester.

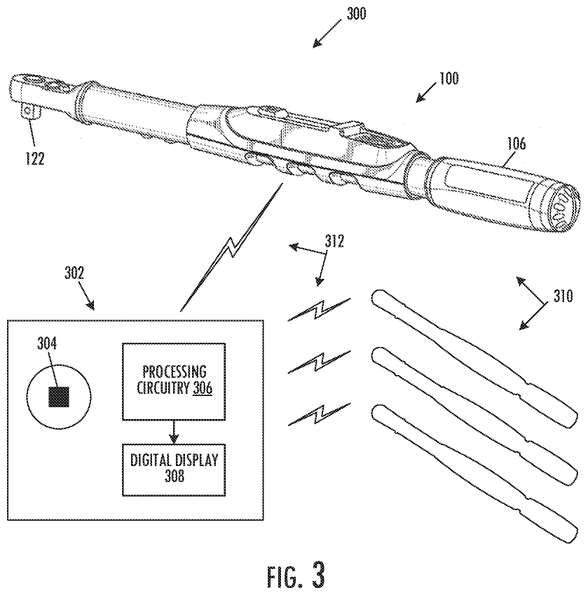

FIG. 3 illustrates a system 300 for verifying a torque measurement device 200 such as an electronic torque wrench 100 of multiple electronic torque wrenches, according to various example implementations. According to various example implementations, the system includes the the torque mesaurement device and an apparatus for calibrating the torque measurement device. The apparatus may be embodied in a number of different manners. In the example shown in FIG. 3 in which the torque measurement device is an electronic torque wrench, the apparatus is embodied as a torque tester 302 that the electronic torque wrench is configured to engage. In this regard, the torque tester may include a female square drive or recess 304 configured to receive the boss 122 of the electronic torque wrench. The torque tester may include circuitry that is the same as or similar to the torque measurement device 200, including processing circuitry 306 and a digital display 308.

During verification of an electronic torque wrench 100, the electronic torque wrench is engaged with the torque tester 302 and a rotational force is applied at the grip handle 106, which produces a torque at the torque tester. The processing circuitry 306 of the torque tester is configured to determine a reference torque value at the torque tester, from the torque applied by the electronic torque wrench. In this regard, the torque tester may be configured to determine the reference torque value in a manner the same as or similar to the processing circuitry 208 of the torque measurement device 200 is configured to determine a torque value.

In some examples, the torque tester 302 and thereby the processing circuitry 306 is configured to receive multiple torque values contemporaneous with the reference torque value determined at the torque tester. The multiple torque values may be received from multiple electronic torque wrenches 310, including the electronic torque wrench engaged with the torque tester. The processing circuitry is configured to identify one of the multiple torque values as a torque value (for verification) from the electronic torque wrench, based on the reference torque value and the multiple torque values.

The one of the multiple torque values may be identified in a number of different manners. In some examples, the one of the multiple torque values is identified as the one within a threshold value of the reference torque value, or the one closest to the reference torque value. In other examples, the one of the multiple torque values is identified as the one for which a rate of change is within a threshold rate of the rate of change of the reference torque value, or the one for which a rate of change is closest to the rate of change of the reference torque value. The one of the multiple torque values may be identified as the one within a threshold value of the reference torque value, and for which a rate of change is within a threshold rate of the rate of change of the reference torque value. Or the one of the multiple torque values may be identified as the one closest to the reference torque value, and for which a rate of change is closest to the rate of change of the reference torque value.

Regardless of the exact manner by which the one of the multiple torque values is identified as the torque value, the processing circuitry 306 is configured to perform a verification of the electronic torque wrench 100 based on the reference torque value and the torque value as identified. And the processing circuitry is configured to output an indication of the verification of the electronic torque wrench. The indication of the verification may be output in a number of different manners, such as to the digital display 308 that is configured to display the indication.

In some examples, the processing circuitry 306 is further configured to connect the torque tester 302 to the multiple electronic torque wrenches 310 that are in radio range of the torque tester, and thereby establish radio links 312 over which the multiple torque values are received wirelessly by radio communication. Examples of suitable radio links include one or more of Wi-Fi, Bluetooth, Bluetooth Low Energy, Zigbee or frequency-shift keying (FSK) links. The processing circuitry may be configured to disconnect the electronic torque wrench 100 from the torque tester after the verification of the electronic torque wrench is performed. This may enable the torque tester to repeat the process to verify others of the multiple electronic torque wrenches. That is, the processing circuitry may be further configured to cause the torque tester 302 to repeat the verifying and disconnecting for others of the multiple electronic torque wrenches that are connected to the torque tester after the electronic torque wrench is disconnected.

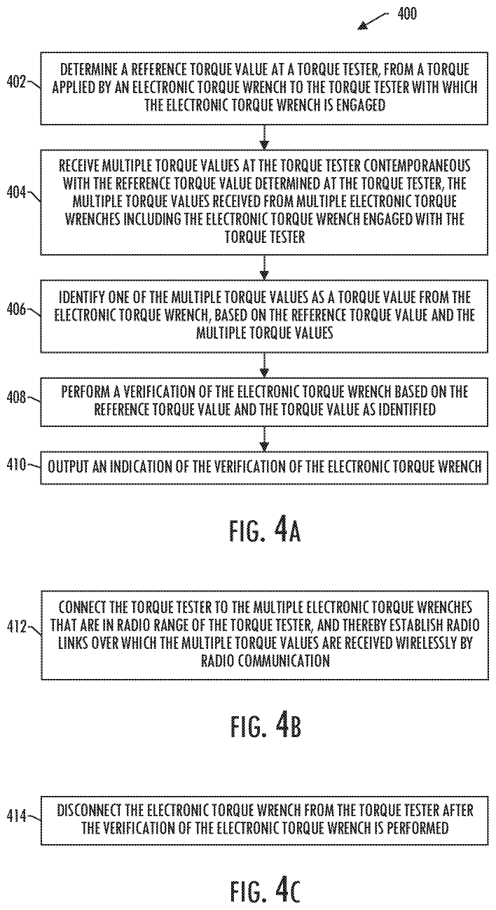

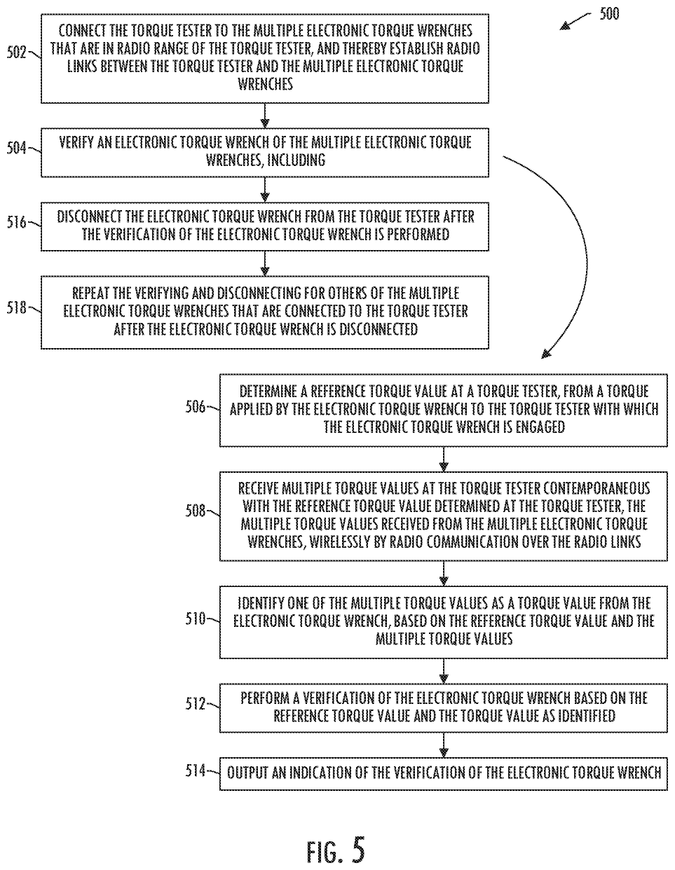

FIGS. 4A-4C are flowcharts illustrating various steps in a method 400 of verifying an electronic torque wrench, according to various example implementations. The method includes determining a reference torque value at a torque tester, from a torque applied by an electronic torque wrench to the torque tester with which the electronic torque wrench is engaged, as shown at block 402 of FIG. 4A. The method includes receiving multiple torque values at the torque tester contemporaneous with the reference torque value determined at the torque tester, the multiple torque values received from multiple electronic torque wrenches, including the electronic torque wrench engaged with the torque tester, as shown at block 404.

The method 400 includes identifying one of the multiple torque values as a torque value from the electronic torque wrench, based on the reference torque value and the multiple torque values, as shown at block 406. The method includes performing a verification of the electronic torque wrench based on the reference torque value and the torque value as identified, as shown at block 408. And the method includes outputting an indication of the verification of the electronic torque wrench, as shown at block 410.

In some examples, the one of the multiple torque values is identified at block 406 as the one within a threshold value of the reference torque value.

In some examples, the one of the multiple torque values is identified at block 406 as the one for which a rate of change is within a threshold rate of the rate of change of the reference torque value.

In some examples, the one of the multiple torque values is identified at block 406 as the one within a threshold value of the reference torque value, and for which a rate of change is within a threshold rate of the rate of change of the reference torque value.

In some examples, the one of the multiple torque values is identified at block 406 as the one closest to the reference torque value.

In some examples, the one of the multiple torque values is identified at block 406 as the one for which a rate of change is closest to the rate of change of the reference torque value.

In some examples, the one of the multiple torque values is identified at block 406 as the one closest to the reference torque value, and for which a rate of change is closest to the rate of change of the reference torque value.

In some examples, the method 400 further includes connecting the torque tester to the multiple electronic torque wrenches that are in radio range of the torque tester, and thereby establish radio links over which the multiple torque values are received wirelessly by radio communication, as shown at block 412 of FIG. 4B.

In some examples, the radio links include one or more of Wi-Fi, Bluetooth, Bluetooth Low Energy, Zigbee or frequency-shift keying (FSK) links.

In some examples, the method 400 further includes disconnecting the electronic torque wrench from the torque tester after the verification of the electronic torque wrench is performed, as shown at block 414 of FIG. 4C.

FIG. 5 is a flowchart illustrating various steps in a method 500 of verifying multiple electronic torque wrenches, according to various example implementations. The method includes connecting the torque tester to the multiple electronic torque wrenches that are in radio range of the torque tester, and thereby establish radio links between the torque tester and the multiple electronic torque wrenches, as shown at block 502. The method includes verifying an electronic torque wrench of the multiple electronic torque wrenches, as shown at block 504.

Verifing the electronic torque wrench at block 504 includes determining at block 506 a reference torque value at a torque tester, from a torque applied by the electronic torque wrench to the torque tester with which the electronic torque wrench is engaged. Multiple torque values are received at the torque tester contemporaneous with the reference torque value determined at the torque tester, the multiple torque values received from the multiple electronic torque wrenches, wirelessly by radio communication over the radio links, as shown at block 508. One of the multiple torque values is identified as a torque value from the electronic torque wrench, based on the reference torque value and the multiple torque values, as shown at block 510. A verification of the electronic torque wrench is performed based on the reference torque value and the torque value as identified, as shown at block 512. And an indication of the verification of the electronic torque wrench is output, as shown at block 514.

As also shown, the method 500 includes disconnecting the electronic torque wrench from the torque tester after the verification of the electronic torque wrench is performed, as shown at block 516. And the method includes repeating the verifying and disconnecting for others of the multiple electronic torque wrenches that are connected to the torque tester after the electronic torque wrench is disconnected, as shown at block 518.

In some examples, the radio links include one or more of Wi-Fi, Bluetooth, Bluetooth Low Energy, Zigbee or frequency-shift keying (FSK) links.

In some examples, the one of the multiple torque values is identified at block 510 as the one within a threshold value of the reference torque value.

In some examples, the one of the multiple torque values is identified at block 510 as the one for which a rate of change is within a threshold rate of the rate of change of the reference torque value.

In some examples, the one of the multiple torque values is identified at block 510 as the one within a threshold value of the reference torque value, and for which a rate of change is within a threshold rate of the rate of change of the reference torque value.

In some examples, the one of the multiple torque values is identified at block 510 as the one closest to the reference torque value.

In some examples, the one of the multiple torque values is identified at block 510 as the one for which a rate of change is closest to the rate of change of the reference torque value.

In some examples, the one of the multiple torque values is identified at block 510 as the one closest to the reference torque value, and for which a rate of change is closest to the rate of change of the reference torque value.

As explained above and reiterated below, the present disclosure includes, without limitation, the following example implementations.

Clause 1. A torque tester for verifying an electronic torque wrench, the torque tester comprising: a recess configured to engage a boss of an electronic torque wrench, and thereby engage the electronic torque wrench with the torque tester; and processing circuitry configured to cause the torque tester to at least: determine a reference torque value at a torque tester, from a torque applied by an electronic torque wrench to the torque tester with which the electronic torque wrench is engaged; receive multiple torque values at the torque tester contemporaneous with the reference torque value determined at the torque tester, the multiple torque values received from multiple electronic torque wrenches, including the electronic torque wrench engaged with the torque tester; identify one of the multiple torque values as a torque value from the electronic torque wrench, based on the reference torque value and the multiple torque values; perform a verification of the electronic torque wrench based on the reference torque value and the torque value as identified; and output an indication of the verification of the electronic torque wrench.

Clause 2. The torque tester of clause 1, wherein the one of the multiple torque values is identified as the one within a threshold value of the reference torque value.

Clause 3. The torque tester of clause 1 or clause 2, wherein the one of the multiple torque values is identified as the one for which a rate of change is within a threshold rate of the rate of change of the reference torque value.

Clause 4. The torque tester of any of clauses 1 to 3, wherein the one of the multiple torque values is identified as the one within a threshold value of the reference torque value, and for which a rate of change is within a threshold rate of the rate of change of the reference torque value.

Clause 5. The torque tester of any of clauses 1 to 4, wherein the one of the

multiple torque values is identified as the one closest to the reference torque value.

Clause 6. The torque tester of any of clauses 1 to 5, wherein the one of the multiple torque values is identified as the one for which a rate of change is closest to the rate of change of the reference torque value.

Clause 7. The torque tester of any of clauses 1 to 6, wherein the one of the multiple torque values is identified as the one closest to the reference torque value, and for which a rate of change is closest to the rate of change of the reference torque value.

Clause 8. The torque tester of any of clauses 1 to 7, wherein the processing circuitry is configured to cause the torque tester to further connect the torque tester to the multiple electronic torque wrenches that are in radio range of the torque tester, and thereby establish radio links over which the multiple torque values are received wirelessly by radio communication.

Clause 9. The torque tester of clause 8, wherein the radio links include one or more of Wi-Fi, Bluetooth, Bluetooth Low Energy, Zigbee or frequency-shift keying (FSK) links.

Clause 10. The torque tester of clause 8 or clause 9, wherein the processing circuitry is configured to cause the torque tester to further disconnect the electronic torque wrench from the torque tester after the verification of the electronic torque wrench is performed.

Clause 11. A torque tester for verifying multiple electronic torque wrenches, the torque tester comprising: a recess configured to engage a boss of an electronic torque wrench, and thereby engage the electronic torque wrench with the torque tester; and processing circuitry configured to cause the torque tester to at least: connect the torque tester to the multiple electronic torque wrenches that are in radio range of the torque tester, and thereby establish radio links between the torque tester and the multiple electronic torque wrenches; verify an electronic torque wrench of the multiple electronic torque wrenches, including the torque tester caused to: determine a reference torque value at a torque tester, from a torque applied by the electronic torque wrench to the torque tester with which the electronic torque wrench is engaged; receive multiple torque values at the torque tester contemporaneous with the reference torque value determined at the torque tester, the multiple torque values received from the multiple electronic torque wrenches, wirelessly by radio communication over the radio links; identify one of the multiple torque values as a torque value from the electronic torque wrench, based on the reference torque value and the multiple torque values; perform a verification of the electronic torque wrench based on the reference torque value and the torque value as identified; and output an indication of the verification of the electronic torque wrench; disconnect the electronic torque wrench from the torque tester after the verification of the electronic torque wrench is performed; and repeat the verifying and disconnecting for others of the multiple electronic torque wrenches that are connected to the torque tester after the electronic torque wrench is disconnected.

Clause 12. The torque tester of clause 11, wherein the radio links include one or more of Wi-Fi, Bluetooth, Bluetooth Low Energy, Zigbee or frequency-shift keying (FSK) links.

Clause 13. The torque tester of clause 11 or clause 12, wherein the one of the multiple torque values is identified as the one within a threshold value of the reference torque value.

Clause 14. The torque tester of any of clauses 11 to 13, wherein the one of the multiple torque values is identified as the one for which a rate of change is within a threshold rate of the rate of change of the reference torque value.

Clause 15. The torque tester of any of clauses 11 to 14, wherein the one of the multiple torque values is identified as the one within a threshold value of the reference torque value, and for which a rate of change is within a threshold rate of the rate of change of the reference torque value.

Clause 16. The torque tester of any of clauses 11 to 15, wherein the one of the multiple torque values is identified as the one closest to the reference torque value.

Clause 17. The torque tester of any of clauses 11 to 16, wherein the one of the multiple torque values is identified as the one for which a rate of change is closest to the rate of change of the reference torque value.

Clause 18. The torque tester of any of clauses 11 to 17, wherein the one of the multiple torque values is identified as the one closest to the reference torque value, and for which a rate of change is closest to the rate of change of the reference torque value.

Clause 19. A method of verifying an electronic torque wrench, the method comprising: determining a reference torque value at a torque tester, from a torque applied by an electronic torque wrench to the torque tester with which the electronic torque wrench is engaged; receiving multiple torque values at the torque tester contemporaneous with the reference torque value determined at the torque tester, the multiple torque values received from multiple electronic torque wrenches, including the electronic torque wrench engaged with the torque tester; identifying one of the multiple torque values as a torque value from the electronic torque wrench, based on the reference torque value and the multiple torque values; performing a verification of the electronic torque wrench based on the reference torque value and the torque value as identified; and outputting an indication of the verification of the electronic torque wrench.

Clause 20. The method of clause 19, wherein the one of the multiple torque values is identified as the one within a threshold value of the reference torque value.

Clause 21. The method of clause 19 or clause 20, wherein the one of the multiple torque values is identified as the one for which a rate of change is within a threshold rate of the rate of change of the reference torque value.

Clause 22. The method of any of clauses 19 to 21, wherein the one of the multiple torque values is identified as the one within a threshold value of the reference torque value, and for which a rate of change is within a threshold rate of the rate of change of the reference torque value.

Clause 23. The method of any of clauses 19 to 22, wherein the one of the multiple torque values is identified as the one closest to the reference torque value.

Clause 24. The method of any of clauses 19 to 23, wherein the one of the multiple torque values is identified as the one for which a rate of change is closest to the rate of change of the reference torque value.

Clause 25. The method of any of clauses 19 to 24, wherein the one of the multiple torque values is identified as the one closest to the reference torque value, and for which a rate of change is closest to the rate of change of the reference torque value.

Clause 26. The method of any of clauses 19 to 25, wherein the method further comprises connecting the torque tester to the multiple electronic torque wrenches that are in radio range of the torque tester, and thereby establish radio links over which the multiple torque values are received wirelessly by radio communication.

Clause 27. The method of clause 26, wherein the radio links include one or more of Wi-Fi, Bluetooth, Bluetooth Low Energy, Zigbee or frequency-shift keying (FSK) links.

Clause 28. The method of clause 26 or clause 27, wherein the method further comprises disconnecting the electronic torque wrench from the torque tester after the verification of the electronic torque wrench is performed.

Clause 29. A method of verifying multiple electronic torque wrenches, the method comprising: connecting the torque tester to the multiple electronic torque wrenches that are in radio range of the torque tester, and thereby establish radio links between the torque tester and the multiple electronic torque wrenches; verifying an electronic torque wrench of the multiple electronic torque wrenches, including: determining a reference torque value at a torque tester, from a torque applied by the electronic torque wrench to the torque tester with which the electronic torque wrench is engaged; receiving multiple torque values at the torque tester contemporaneous with the reference torque value determined at the torque tester, the multiple torque values received from the multiple electronic torque wrenches, wirelessly by radio communication over the radio links; identifying one of the multiple torque values as a torque value from the electronic torque wrench, based on the reference torque value and the multiple torque values; performing a verification of the electronic torque wrench based on the reference torque value and the torque value as identified; and outputting an indication of the verification of the electronic torque wrench; disconnecting the electronic torque wrench from the torque tester after the verification of the electronic torque wrench is performed; and repeating the verifying and disconnecting for others of the multiple electronic torque wrenches that are connected to the torque tester after the electronic torque wrench is disconnected.

Clause 30. The method of clause 29, wherein the radio links include one or more of Wi-Fi, Bluetooth, Bluetooth Low Energy, Zigbee or frequency-shift keying (FSK) links.

Clause 31. The method of clause 29 or clause 30, wherein the one of the multiple torque values is identified as the one within a threshold value of the reference torque value.

Clause 32. The method of any of clauses 29 to 31, wherein the one of the multiple torque values is identified as the one for which a rate of change is within a threshold rate of the rate of change of the reference torque value.

Clause 33. The method of any of clauses 29 to 32, wherein the one of the multiple torque values is identified as the one within a threshold value of the reference torque value, and for which a rate of change is within a threshold rate of the rate of change of the reference torque value.

Clause 34. The method of any of clauses 29 to 33, wherein the one of the multiple torque values is identified as the one closest to the reference torque value.

Clause 35. The method of any of clauses 29 to 34, wherein the one of the multiple torque values is identified as the one for which a rate of change is closest to the rate of change of the reference torque value.

Clause 36. The method of any of clauses 29 to 35, wherein the one of the multiple torque values is identified as the one closest to the reference torque value, and for which a rate of change is closest to the rate of change of the reference torque value.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A torque tester for verifying an electronic torque wrench, the torque tester comprising:
a recess configured to engage a boss of an electronic torque wrench, and thereby engage the electronic torque wrench with the torque tester; and
processing circuitry configured to cause the torque tester to at least:
determine a reference torque value at a torque tester, from a torque applied by an electronic torque wrench to the torque tester with which the electronic torque wrench is engaged;
receive multiple torque values at the torque tester contemporaneous with the reference torque value determined at the torque tester, the multiple torque values received from multiple electronic torque wrenches, including the electronic torque wrench engaged with the torque tester;
identify one of the multiple torque values as a torque value from the electronic torque wrench, based on the reference torque value and the multiple torque values;
perform a verification of the electronic torque wrench based on the reference torque value and the torque value as identified; and
output an indication of the verification of the electronic torque wrench.

2. The torque tester of claim 1, wherein the one of the multiple torque values is identified as the one within a threshold value of the reference torque value, or the one closest to the reference torque value.

3. The torque tester of claim 1, wherein the one of the multiple torque values is identified as the one for which a rate of change is within a threshold rate of the rate of change of the reference torque value, or the one for which the rate of change is closest to the rate of change of the reference torque value.

4. The torque tester of claim 1, wherein the one of the multiple torque values is identified as the one within a threshold value of the reference torque value, and for which a rate of change is within a threshold rate of the rate of change of the reference torque value.

5. The torque tester of claim 1, wherein the one of the multiple torque values is identified as the one closest to the reference torque value, and for which a rate of change is closest to the rate of change of the reference torque value.

6. The torque tester of claim 1, wherein the processing circuitry is configured to cause the torque tester to further connect the torque tester to the multiple electronic torque wrenches that are in radio range of the torque tester, and thereby establish radio links over which the multiple torque values are received wirelessly by radio communication.

7. The torque tester of claim 6, wherein the radio links include one or more of Wi-Fi, Bluetooth, Bluetooth Low Energy, Zigbee or frequency-shift keying (FSK) links.

8. The torque tester of claim 6, wherein the processing circuitry is configured to cause the torque tester to further disconnect the electronic torque wrench from the torque tester after the verification of the electronic torque wrench is performed.

9. A torque tester for verifying multiple electronic torque wrenches, the torque tester comprising:
a recess configured to engage a boss of an electronic torque wrench, and thereby engage the electronic torque wrench with the torque tester; and
processing circuitry configured to cause the torque tester to at least:
connect the torque tester to the multiple electronic torque wrenches that are in radio range of the torque tester, and thereby establish radio links between the torque tester and the multiple electronic torque wrenches;
verify an electronic torque wrench of the multiple electronic torque wrenches, including the torque tester caused to:
determine a reference torque value at a torque tester, from a torque applied by the electronic torque wrench to the torque tester with which the electronic torque wrench is engaged;
receive multiple torque values at the torque tester contemporaneous with the reference torque value determined at the torque tester, the multiple torque values received from the multiple electronic torque wrenches, wirelessly by radio communication over the radio links;
identify one of the multiple torque values as a torque value from the electronic torque wrench, based on the reference torque value and the multiple torque values;
perform a verification of the electronic torque wrench based on the reference torque value and the torque value as identified; and
output an indication of the verification of the electronic torque wrench;
disconnect the electronic torque wrench from the torque tester after the verification of the electronic torque wrench is performed; and
repeat the verifying and disconnecting for others of the multiple electronic torque wrenches that are connected to the torque tester after the electronic torque wrench is disconnected.

10. The torque tester of claim 9, wherein the radio links include one or more of Wi-Fi, Bluetooth, Bluetooth Low Energy, Zigbee or frequency-shift keying (FSK) links.

11. The torque tester of claim 9, wherein the one of the multiple torque values is identified as the one within a threshold value of the reference torque value, or the one closest to the reference torque value.

12. The torque tester of claim 9, wherein the one of the multiple torque values is identified as the one for which a rate of change is within a threshold rate of the rate of change of the reference torque value, or the one for which the rate of change is closest to the rate of change of the reference torque value.

13. The torque tester of claim 9, wherein the one of the multiple torque values is identified as the one within a threshold value of the reference torque value, and for which a rate of change is within a threshold rate of the rate of change of the reference torque value.

14. The torque tester of claim 9, wherein the one of the multiple torque values is identified as the one closest to the reference torque value, and for which a rate of change is closest to the rate of change of the reference torque value.

15. A method of verifying an electronic torque wrench, the method comprising:
determining a reference torque value at a torque tester, from a torque applied by an electronic torque wrench to the torque tester with which the electronic torque wrench is engaged;
receiving multiple torque values at the torque tester contemporaneous with the reference torque value determined at the torque tester, the multiple torque values received from multiple electronic torque wrenches, including the electronic torque wrench engaged with the torque tester;
identifying one of the multiple torque values as a torque value from the electronic torque wrench, based on the reference torque value and the multiple torque values;
performing a verification of the electronic torque wrench based on the reference torque value and the torque value as identified; and
outputting an indication of the verification of the electronic torque wrench.

16. The method of claim 15, wherein the one of the multiple torque values is identified as the one within a threshold value of the reference torque value, or the one closest to the reference torque value.

17. The method of claim 15, wherein the one of the multiple torque values is identified as the one for which a rate of change is within a threshold rate of the rate of change of the reference torque value, or the one for which the rate of change is closest to the rate of change of the reference torque value.

18. The method of claim 15, wherein the one of the multiple torque values is identified as the one within a threshold value of the reference torque value, and for which a rate of change is within a threshold rate of the rate of change of the reference torque value.

19. The method of claim 15, wherein the one of the multiple torque values is identified as the one closest to the reference torque value, and for which a rate of change is closest to the rate of change of the reference torque value.

20. The method of claim 15, wherein the method further comprises connecting the torque tester to the multiple electronic torque wrenches that are in radio range of the torque tester, and thereby establish radio links over which the multiple torque values are received wirelessly by radio communication.

21. The method of claim 20, wherein the method further comprises disconnecting the electronic torque wrench from the torque tester after the verification of the electronic torque wrench is performed.
